(19) United States
(12) Patent Application Publication
(10) Pub. No.: US 2025/0208456 A1
(43) Pub. Date: Jun. 26, 2025

(54) DISPLAY DEVICE AND CASING

(71) Applicant: Japan Display Inc., Tokyo (JP)

(72) Inventors: Yuta WAKABAYASHI, Tokyo (JP); Yasuyuki HANAZAWA, Tokyo (JP)

(73) Assignee: Japan Display Inc., Tokyo (JP)

(21) Appl. No.: 19/000,779

(22) Filed: Dec. 24, 2024

(30) Foreign Application Priority Data
Dec. 26, 2023 (JP) 2023-219342

(51) Int. Cl. G02F 1/1333; G02F 1/1334; G02F 1/1345

(52) U.S. Cl. CPC G02F 1/133317; G02F 1/133331; G02F 1/1334; G02F 1/1345

(57) ABSTRACT

According to one embodiment, a display device includes a display panel and a casing. The display panel includes a first surface, a second surface on a side opposite to the first surface, and a mounting area including a terminal. A background of a side of the second surface is visually recognizable from a side of the first surface. A background of the side of the first surface is visually recognizable from the side of the second surface. The casing supports the display panel. The casing includes a body portion covering the mounting area, and a transparent frame portion connected to the body portion.

### CROSS-REFERENCE TO RELATED APPLICATIONS

This application is based upon and claims the benefit of priority from Japanese Patent Application No. 2023-219342, filed Dec. 26, 2023, the entire contents of which are incorporated herein by reference.

### FIELD

Embodiments described herein relate generally to a display device and a casing.

### BACKGROUND

In recent years, a display device comprising a display panel including a polymer dispersed liquid crystal layer (PDLC), a light source, and the like has been proposed. The polymer dispersed liquid crystal layer can switch a scattering state in which light is scattered and a transparent state in which light is transmitted.

The display device can display images in the scattering state. In contrast, a user can visually recognize a background through the display panel by switching the display panel to the transparent state. In the display panel through which a background can be visually recognized, a casing for supporting the display panel without impairing aesthetic appearance is required.

### BRIEF DESCRIPTION OF THE DRAWINGS

FIG. 1 is a schematic perspective view showing an example of a display device of an embodiment.

FIG. 2 is a diagram showing a configuration example of the display device of an embodiment.

FIG. 3 is a schematic cross-sectional view showing the display device of an embodiment.

FIG. 4 is a diagram showing an example of a configuration applicable to the vicinity of a mounting area.

FIG. 5 is a diagram showing an example of a configuration applicable to the vicinity of the mounting area.

FIG. 6 is a diagram showing the vicinity of the mounting area of a display panel from which a holding member, a light source unit, and a light guide are removed.

FIG. 7 is a schematic cross-sectional view of the display device along the VII-VII line in FIG. 4.

FIG. 8 is an exploded perspective view showing a casing of an embodiment.

FIG. 9 is a front view showing the casing of an embodiment.

FIG. 10 is a side view showing the casing of an embodiment.

FIG. 11 is a top view showing the casing of an embodiment.

FIG. 12 is a schematic cross-sectional view of the display device along the XII-XII line in FIG. 1.

FIG. 13 is a schematic cross-sectional view showing the display device along line XIII-XIII in FIG. 1.

FIG. 14 is a diagram for explaining the relationship between a first frame and a supporting member.

FIG. 15 is a diagram for explaining the relationship among the first frame, the supporting member, and a cover member.

### DETAILED DESCRIPTION

In general, according to one embodiment, a display device comprises a display panel and a casing. The display panel includes a first surface, a second surface on a side opposite to the first surface, and a mounting area including a terminal. A background of a side of the second surface is visually recognizable from a side of the first surface. A background of the side of the first surface is visually recognizable from the side of the second surface. The casing supports the display panel. The casing includes a body portion covering the mounting area, and a transparent frame portion connected to the body portion.

In addition, according to one embodiment, a casing supports a display panel. The display panel includes a first surface, a second surface on a side opposite to the first surface, and a terminal included in a mounting area. A background of a side of the second surface is visually recognizable from a side of the first surface. A background of the side of the first surface is visually recognizable from the side of the second surface. The casing includes a body portion covering the mounting area of the display panel, and a transparent frame portion connected to the body portion.

According to this configuration, a display device and a casing that are capable of improving the aesthetic appearance can be provided.

An embodiment will be described with reference to the accompanying drawings.

The disclosure is merely an example, and proper changes in keeping with the spirit of the invention, which are easily conceivable by a person of ordinary skill in the art, come within the scope of the invention as a matter of course. In addition, in some cases, in order to make the description clearer, the widths, thicknesses, shapes, etc., of the respective parts are schematically illustrated in the drawings, compared to the actual modes. However, the schematic illustration is merely an example, and adds no restrictions to the interpretation of the invention. In addition, in the specification and drawings, structural elements which function in the same or a similar manner to those described in connection with preceding drawings are denoted by like reference numbers, detailed description thereof being omitted unless necessary.

In the figures, an X-axis, a Y-axis, and a Z-axis orthogonal to each other are described to facilitate understanding as needed. A direction parallel to the X-axis is referred to as a first direction X. A direction parallel to the Y-axis is referred to as a second direction Y. A direction parallel to the Z-axis is referred to as a third direction Z.

The present embodiment discloses a liquid crystal display device with high translucency to which polymer dispersed liquid crystal is applied (so-called transparent display) as an example of the display device. However, the configuration disclosed in the present embodiment can be applied to other types of display devices.

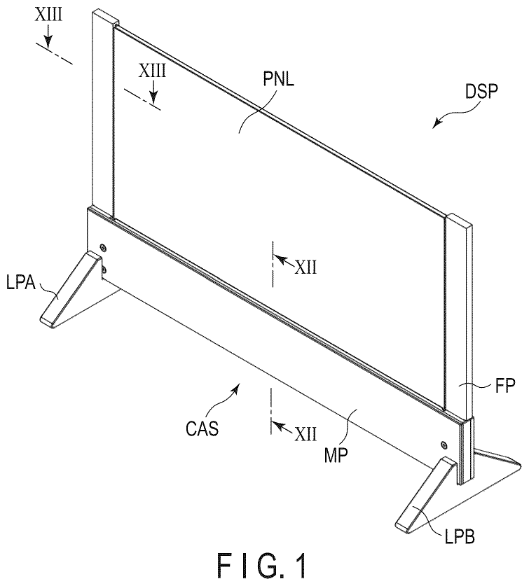

FIG. 1 is a schematic perspective view showing an example of a display device DSP of the present embodiment. The display device DSP comprises a display panel PNL and a casing CAS. The display device DSP further comprises a light source unit to be described later.

As shown in FIG. 1, the display device DSP is configured to be able to independently stand on an installation surface of a table and the like. Thus, the display device DSP can be used as a monitor. The display device DSP can be provided at a position between users facing each other.

The casing CAS supports the display panel PNL. The casing CAS includes a body portion MP, leg portions LPA and LPB connected to the body portion MP, and a frame portion FP connected to the body portion MP.

The casing CAS is configured to be able to stand by means of the leg portions LPA and LPB. The leg portions LPA and LPB are provided at respective end portions of the body portion MP in the width direction. The detail of the casing CAS is to be described later.

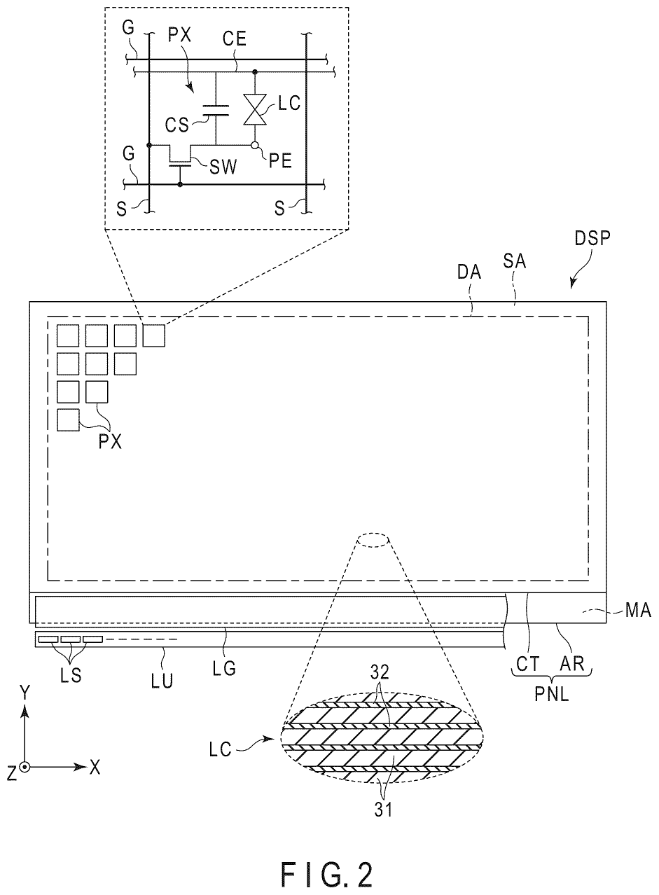

FIG. 2 is a diagram showing a configuration example of the display device DSP of the present embodiment. In FIG. 2, the illustration of the casing CAS and the like is omitted. In FIG. 2, the display device DSP is viewed in a direction opposite to the third direction Z.

The display device DSP comprises the display panel PNL, a light source unit LU, and a light guide LG. In FIG. 2, parts of the light source unit LU and the light guide LG are represented by the break line and the illustration of these portions is omitted.

The display panel PNL comprises an array substrate AR and a counter-substrate CT stacked in the third direction Z. The counter-substrate CT faces the array substrate AR. Each of the array substrate AR and the counter-substrate CT in FIG. 2 has a rectangular shape elongating in the first direction X. The array substrate AR and the counter-substrate CT may have a shape different from this example.

The width of the array substrate AR in the second direction Y is greater than the width of the counter-substrate CT in the second direction Y. By this configuration, the array substrate AR includes a mounting area MA provided at a position not overlapping the counter-substrate CT. The mounting area MA and the counter-substrate CT are arranged in the second direction Y in a planar view. The first direction X corresponds to longitudinal direction of the mounting area MA. In the mounting area MA, a flexible printed circuit board to be described later and the like are mounted.

The display panel PNL includes a display area DA which displays an image and a surrounding area SA having a frame shape around the display area DA. Both the display area DA and the surrounding area SA are formed on portions on which the array substrate AR overlaps the counter-substrate CT. The display area DA comprises a plurality of pixels PX arrayed in a matrix in the first direction X and the second direction Y.

The display panel PNL further includes a liquid crystal layer LC enclosed between the array substrate AR and the counter-substrate CT. As shown in a lower side of FIG. 2 in the enlarged and schematic manner, the liquid crystal layer LC is composed of polymer dispersed liquid crystals containing polymers 31 and liquid crystal molecules 32.

For example, the polymers 31 are liquid crystal polymers. The polymers 31 are formed in a stripe shape extending along the first direction X and are arranged in the second direction Y. The liquid crystal molecules 32 are dispersed in gaps between the polymers 31 and are arranged such that axes of the liquid crystal molecules 32 are along the first direction X.

Each of the polymers 31 and the liquid crystal molecules 32 has optical anisotropy or refractive anisotropy. The responsive property of the polymers 31 to the electric field is lower than the responsive property of the liquid crystal molecules 32 to the electric field. For example, the alignment direction of the polymers 31 hardly varies irrespective of the presence or absence of the electric field. In contrast, the alignment direction of the liquid crystal molecules 32 varies in response to a voltage applied to the liquid crystal layer LC.

In a state where no voltage is applied to the liquid crystal layer LC, the optical axes of the polymers 31 are parallel to those of the liquid crystal molecules 32, and the light made incident on the liquid crystal layer LC is not substantially scattered inside the liquid crystal layer LC and passes through the liquid crystal layer LC (transparent state).

In a state where a voltage is applied to the liquid crystal layer LC, the optical axes of the polymers 31 intersect those of the liquid crystal molecules 32, and the light made incident on the liquid crystal layer LC is scattered inside the liquid crystal layer LC (scattered state).

As shown in the upper side of FIG. 2 in the expanded manner, a plurality of scanning lines G and a plurality of signal lines S are provided in the display area DA. The plurality of scanning lines G extend in the first direction X and are arranged in the second direction Y. The plurality of signal lines S extend in the second direction Y and are arranged in the first direction X.

Each pixel PX comprises a switching element SW, a pixel electrode PE, a common electrode CE, and a capacity CS. The switching element SW is constituted by, for example, a thin-film transistor (TFT) and is electrically connected to the scanning line G and the signal line S. The pixel electrode PE is electrically connected to the switching element SW.

The liquid crystal layer LC (particularly, the liquid crystal molecules 32) is driven by an electric field produced between the pixel electrode PE and the common electrode CE. The capacitor CS is formed, for example, between the common electrode CE and an electrode having the same electric potential as the common electrode CE and between the pixel electrode PE and an electrode having the same potential as the pixel electrode PE.

The light source unit LU and the light guide LG are provided along the mounting area MA. The light source unit LU comprises a plurality of light sources LS arranged in the first direction X. Each of the plurality of light sources LS emits light to the display panel PNL along the second direction Y via the light guide LG. For example, a lens such as a prism lens can be used as the light guide LG.

For example, the plurality of light sources LS include a light emitting element emitting red light, a light emitting element emitting green light, and a light emitting element emitting blue light. These light emitting elements may be arranged in the first direction X or may be stacked in the third direction Z. Light emitting diodes (LEDs) can be used as the light emitting elements.

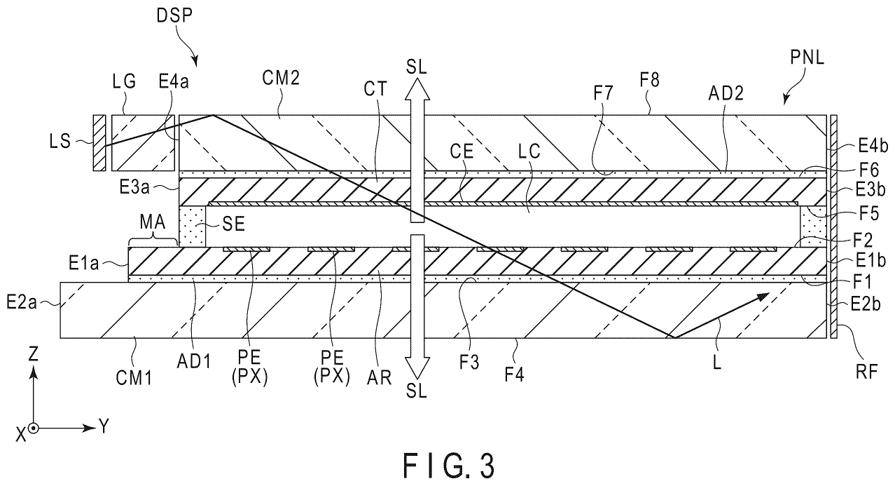

FIG. 3 is a schematic cross-sectional view of the display device DSP of the present embodiment. This figure schematically shows the structure of the display panel PNL and the like and omits the illustration of elements such as the scanning lines G, the signal lines S, and the switching element SW.

The array substrate AR and the counter-substrate CT are bonded together by a sealing material SE. The sealing material SE has a shape which surrounds the display area DA. The liquid crystal layer LC is enclosed in a space surrounded by the sealing material SE.

The array substrate AR comprises the pixel electrodes PE described above. The counter-substrate CT comprises the common electrode CE described above. The pixel electrodes PE face the common electrode CE via the liquid crystal layer LC.

The pixel electrodes PE and the common electrode CE are formed on transparent insulating substrates provided in the array substrate AR and the counter-substrate CT, respectively. These insulating substrates are formed of, for example, glass. However, the insulating substrates may be formed of plastic.

For example, the pixel electrodes PE and the common electrode CE are covered with alignment films formed on each of the array substrate AR and the counter-substrate CT. The layout of the pixel electrodes PE and the common electrode CE is not limited to this example. As another example, the array substrate AR may comprise both the pixel electrodes PE and the common electrode CE.

The display panel PNL further includes cover members CM1 and CM2. In the present embodiment, the cover member CM1 corresponds to a second cover member, and the cover member CM2 corresponds to a first cover member. Both of these cover members CM1 and CM2 are transparent, and are, for example, cover glasses formed of glass.

As another example, the cover members CM1 and CM2 may be formed of plastic. The cover members CM1 and CM2 are sufficiently thicker than the array substrate AR and the counter-substrate CT. For example, each of the cover members CM1 and CM2 has the thickness more than or equal to twice as that of each of the array substrate AR and the counter-substrate CT.

The array substrate AR has a main surface F1, a main surface F2 on a side opposite to the main surface F1, and end faces E1a and E1b, which connect the main surface F1 with the main surface F2. The cover member CM1 includes a main surface F3 facing the main surface F1, a main surface F4 located on a side opposite to the main surface F3, and side surfaces E2a and E2b, which connect the main surface F3 with the main surface F4. In the present embodiment, the main surface F4 corresponds to a second surface.

The main surfaces F1 and F3 are bonded together by a transparent first adhesive layer AD1. For example, optical clear adhesive (OCA) can be used as the first adhesive layer AD1.

The counter-substrate CT includes a main surface F5 facing the second main surface F2 via the liquid crystal layer LC, a main surface F6 on a side opposite to the main surface F5, and side surfaces E3a and E3b, which connect the main surface F5 with the main surface F6. The cover member CM2 includes a main surface F7 facing the main surface F6, a main surface F8 located on a side opposite to the main surface F7, and side surfaces E4a and E4b connecting the main surface F7 with the main surface F8. In the present embodiment, the main surface F8 corresponds to a first surface. The main surface F4 is located on a side opposite to the main surface F8.

The main surfaces F6 and F7 are bonded together by a transparent second adhesive layer AD2. As in the case of the first adhesive layer AD1, OCA can be used as the second adhesive layer AD2 as well.

The side surfaces E1a, E2a, E3a, and E4a are all located on a side of the light source LS (incidence side). The side surfaces E1b, E2b, E3b, and E4b are all located on a side opposite to the light source LS (opposite incidence side). Of the array substrate AR, the mounting area MA is formed in a portion that protrudes relative to the side surface E3a in a direction opposite to the second direction Y.

In the example shown in FIG. 3, the side surfaces E2a, E4a, E2b, and E4b are parallel to the first direction X and the third direction Z. The side surfaces E2a, E4a, E2b, and E4b may have a cross-sectional shape different from this example.

In the example shown in FIG. 3, a reflective material RF is provided in the vicinity of the side surfaces E1b, E2b, E3b, and E4b. The reflective material RF is, for example, a reflective tape attached to the side surfaces E1b, E2b, E3b, and E4b. As another example, the reflective material RF may be a reflective film formed on the side surfaces E1b, E2b, E3b, and E4b.

The light source LS faces the side surface E4a. The light guide LG is provided between the side surface E4a and the light source LS. FIG. 3 shows an example of the path of light L emitted from the light source LS. The light L emitted from the light source LS is made incident on the side surface E4a through the light guide LG.

This light L travels toward the opposite incidence side while repeatedly subjected to total reflection between the main surface F8 and the main surface F4. The light L having reached the side surfaces E1b, E2b, E3b, and E4b is reflected by the reflective material RF and travels toward the incidence side while repeatedly subjected to total reflection between the main surface F8 and the main surface F4.

The light L is hardly scattered on the liquid crystal layer LC in the vicinity of the pixels PX in the transparent state. Thus, the light L does not substantially leak out of the cover member CM1 or the cover member CM2.

On the other hand, the light L is scattered on the liquid crystal layer LC in the vicinity of the pixels PX in the scattered state. This scattered light SL is emitted from the cover member CM1 or the cover member CM2 and is visually recognized as a display image by a user. The gradation expression of the degree of scattering (luminance) can be realized by defining a voltage to be applied to the pixel electrodes PE in stages in a predetermined range.

The external light to be made incident on the cover member CM1 or the cover member CM2 in the pixels PX in the transparent state passes through the liquid crystal layer LC while hardly scattered. Thus, when the display panel PNL is viewed from a side of the cover member CM1 (a side of the main surface F4), a background of a side of the cover member CM2 (a side of the main surface F8) can be visually recognized. When the display device DSP is viewed from a side of the cover member CM2 (the side of the main surface F8), a background of the side of the cover member CM1 (the side of the surface F4) can be visually recognized.

Viewing the display device DSP from the side of the cover member CM1 signifies viewing the display device DSP in the third direction Z. Viewing the display device DSP from the side of the cover member CM2 signifies viewing the display device DSP in a direction opposite to the third direction Z.

For example, as a system for displaying an image by the display device DSP, the following field sequential system can be used. The field sequential system repeats a first subframe in which a red image is displayed by lighting up the red light emitting elements of the plurality of light sources LS, a second subframe in which a green image is displayed by lighting up the green light emitting elements, and a third subframe in which a blue image is displayed by lighting up the blue light emitting elements.

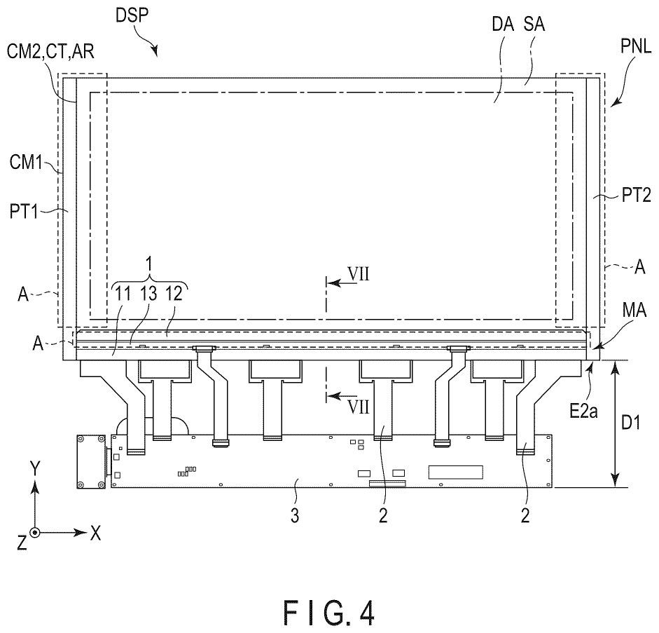

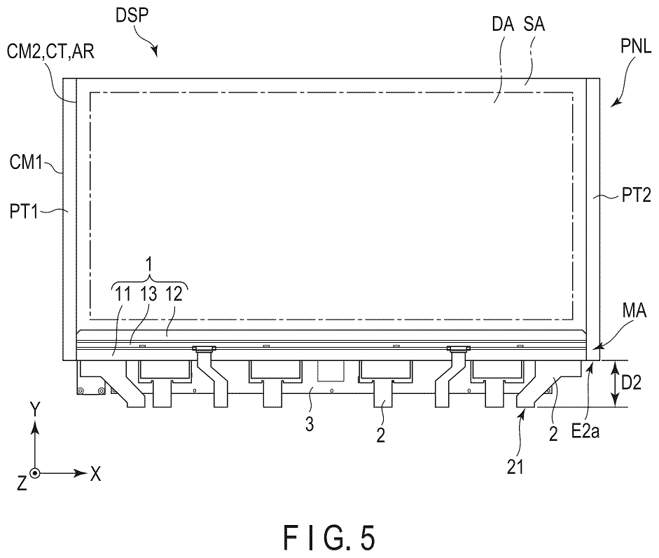

FIG. 4 and FIG. 5 are diagrams showing examples of configurations applicable to the vicinity of the mounting area MA. FIG. 5 shows the state where the display panel PNL is accommodated in the casing CAS. FIG. 4 and FIG. 5 show the display panel PNL viewed in the direction opposite to the third direction Z.

As shown in FIG. 4 and FIG. 5, the display device DSP comprises a holding member 1 holding the light source unit LU and the light guide LG. The holding member 1 has a shape elongating in the first direction X and covers the mounting area MA.

For example, the holding member 1 comprises a first portion 11, a second portion 12, and a rib 13 located between the first portion 11 and the second portion 12. The first portion 11 is located on the lower side of the figure relative to the rib 13 (in other words, a side opposite to the display area DA). The second portion 12 is located between the rib 13 and the display area DA.

In the example shown in FIG. 4, the counter-substrate CT and the cover member CM2 have the same plan shapes. In the first direction X, the cover member CM1 has the width greater than the width of each of the array substrate AR, the counter-substrate CT, and the cover member CM2. By this configuration, the both end portions of the cover member CM1 in the first direction X protrude relative to the array substrate AR, the counter-substrate CT, and the cover member CM2.

More specifically, the cover member CM1 includes protruding portions PT1 and PT2 on the respective end portions in the first direction X. In the present embodiment, the protruding portion PT1 corresponds to a first protruding portion and the protruding portion PT2 corresponds to a second protruding portion.

The protruding portion PT1 protrudes relative to the cover member CM2 in a direction opposite to the first direction X. The protruding portion 2 protrudes relative to the cover member CM2 in the first direction X. The protruding portion PT1 protrudes relative to the array substrate AR in a direction opposite to the first direction X. The protruding portion 2 protrudes relative to the array substrate AR in the first direction X. The display area DA is located between the protruding portion PT1 and the protruding portion PT2 in the first direction X. The array substrate AR is located between the protruding portion PT1 and the protruding portion PT2 in the first direction X. Each of the protruding portions PT1 and PT2 has a shape elongating in the second direction Y.

The display device DSP further comprises a plurality of flexible printed circuit boards 2 and a circuit board 3. The flexible printed circuit board 2 has the rigidity smaller than that of the circuit board 3. An end of each of the plurality of flexible printed circuit boards 2 is connected to the mounting area MA. The other end of each of the plurality of flexible printed circuit boards 2 is connected to the circuit board 3, which is a printed circuit board (PCB).

In the example shown in FIG. 5, a portion of the circuit board 3 overlaps the mounting area MA. In the example shown in FIG. 5, the flexible printed circuit board 2 is bent toward the side of the cover member CM2. That is, the flexible printed circuit board 2 has a length sufficient to be bent.

As shown in FIG. 4 and FIG. 5, the distance between the side surface E2a of the cover member CM1 and an end of a member that protrudes farthest from the side surface E2a of the cover member CM1 in the direction opposite to the second direction Y is defined as a distance D1 and a distance D2.

In FIG. 4, the end of the member that protrudes farthest from the side surface E2a in the direction opposite to the second direction Y is an end of the circuit board 3. In FIG. 5, the end of the member that protrudes furthest from the side surface E2a in the direction opposite to the second direction Y is a curved portion 21 of the flexible printed circuit board 2, which has been bent. As shown in FIG. 4 and FIG. 5. the distance D2 is less than the distance D1 (D2<D1). For example, the distance D1 is about 131.5 mm, and the distance D2 is about 47 mm.

The area of the portion protruding relative to the side surface E2a in the direction opposite to the second direction Y can be made smaller by bending the flexible printed circuit board 2 and making the circuit board 3 overlap the mounting area MA. As a result, the area of a frame portion of a side of the installation surface in the display device DSP can be made smaller.

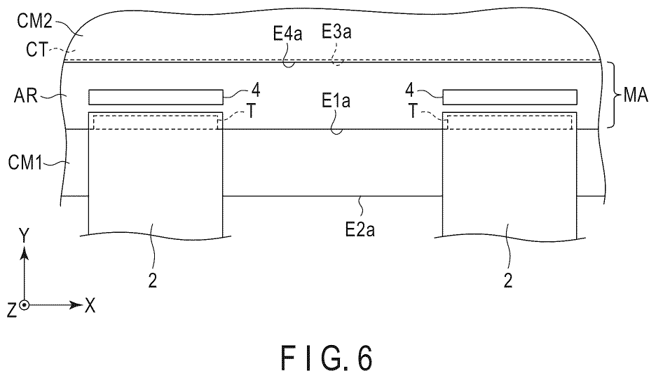

FIG. 6 is a diagram showing the vicinity of the mounting area MA of the display panel PNL from which the holding member 1, the light source unit LU and the light guide LG are removed. A plurality of terminals T are provided in the mounting area MA. The flexible printed circuit board 2 is connected to the terminal T via a conductive adhesive material. Further, a plurality of integrated circuits 4 are mounted in the mounting area MA. In the example shown in FIG. 4, each of the integrated circuits 4 is arranged with the terminal T in the second direction Y.

Drive signals of the array substrate AR are input to the terminals T via the circuit board 3 and the flexible printed circuit board 2. For example, each of the integrated circuits 4 includes a driver which supplies a signal to the scanning line G and the signal line S that are shown in FIG. 1 based on the drive signal input to the terminal T.

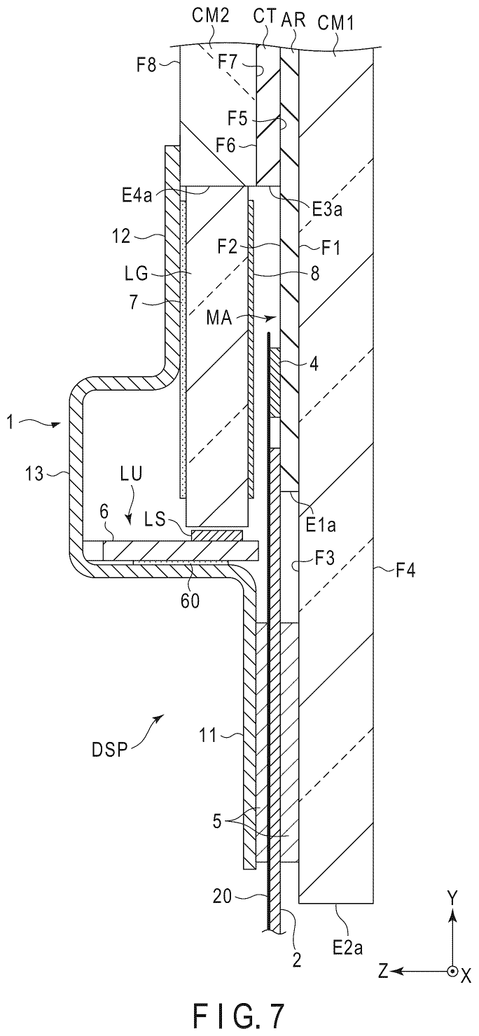

FIG. 7 is a schematic cross-sectional view of the display device DSP along the VII-VII line in FIG. 4. In FIG. 7, the illustration of the adhesive layers AD1 and AD2, the sealing material SE, the liquid crystal layer LC, and the like is omitted.

As described above, the array substrate AR protrudes relative to the side surface E3a of the counter-substrate CT, and the cover member CM1 protrudes relative to the side surface E1a of the array substrate AR. The cover member CM1 protrudes relative to the side surface E4a of the cover member CM2.

In the example shown in FIG. 7, the position of the side surface E3a of the counter-substrate CT is aligned with the position of the side surface E4a of the cover member CM2. Of the array substrate AR, the mounting area MA is formed on a portion protruding relative to the side surfaces E3a and E4a.

A heat radiation sheet 20 may be attached to the flexible printed circuit board 2 and the integrated circuit 4 mounted in the mounting area MA. By this configuration, the increase in the temperature of an integrated circuit 4 by the heat generated at the time of display driving can be suppressed.

For example, the first portion 11, second portion 12, and rib 13, of the holding member 1 are integrally formed by a metal material. Each of the first portion 11 and the second portion 12 has a flat plate shape parallel to the first direction X and the second direction Y.

In the example shown in FIG. 7, the position of the first portion 11 is misaligned with the position of the second portion 12 in the third direction Z. Specifically, the distance between the first portion 11 and the cover member CM1 is shorter than the distance between the second portion 12 and the cover member CM1.

The rib 13 protrudes from the first portion 11 and the second portion 12 in the third direction Z. The rib 13 is provided at a position overlapping the side surface E1a of the array substrate AR in the third direction Z. The first portion 11 is bonded to the main surface F3 of the cover member CM1 by an adhesive member 5.

The light source unit LU comprises a light source substrate 6 on which the light source LS is mounted. The light source substrate 6 is fixed to the holding member 1. The fixing method is not particularly limited. In the example shown in FIG. 7, the light source substrate 6 is bonded to the inner surface of the rib 13 by an adhesive layer 60.

The light guide LG is provided in the space surrounded by the display panel PNL and the holding member 1. The light guide LG is located between the holding member 1 and the mounting area MA in the third direction Z. For example, the light guide LG is bonded to the second portion 12 by an adhesive layer 7 having light reflectivity. A reflective sheet 8 is bonded to a surface facing the mounting area MA, of the light guide LG. These adhesive layer 7 and reflective sheet 8 suppress the emission of light from the light guide LG.

Next, the casing CAS, which the display device DSP comprises, will be described.

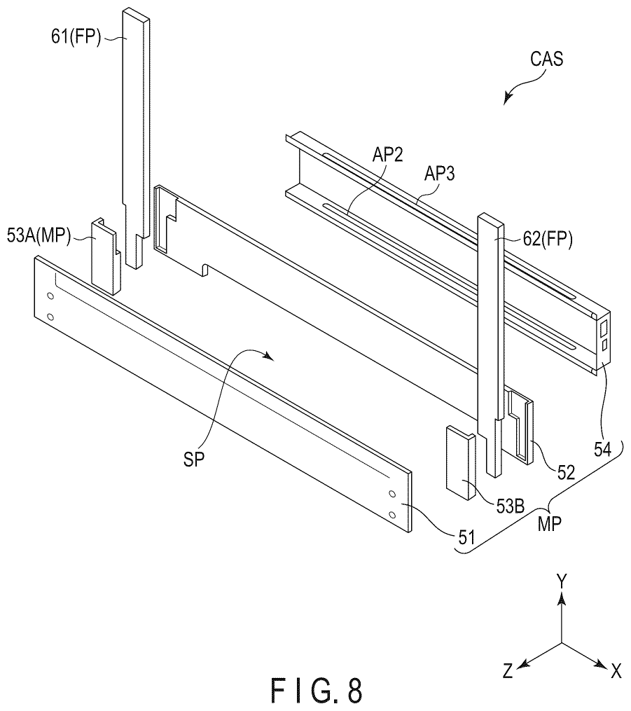

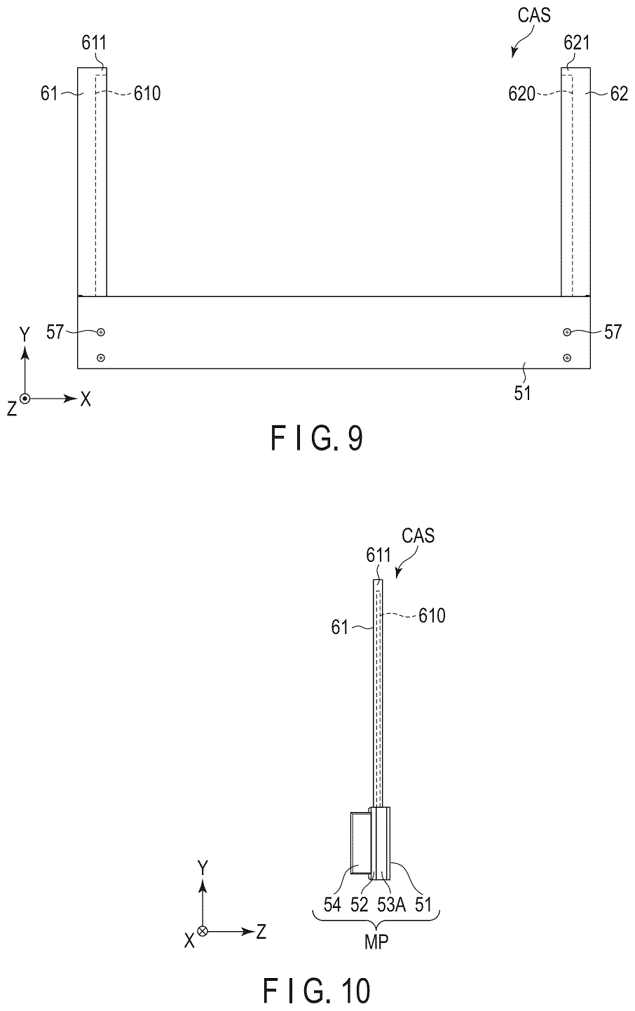

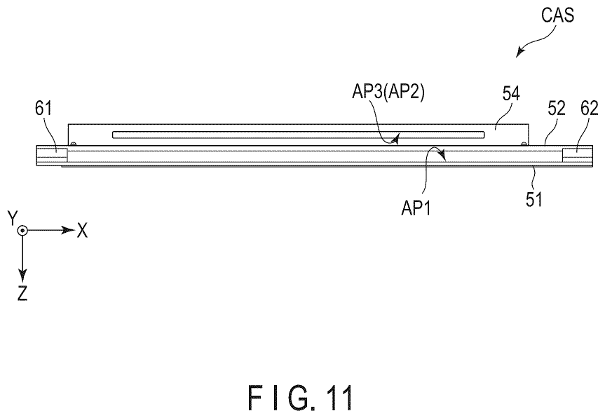

FIG. 8 is an exploded perspective view showing the casing CAS of the present embodiment. FIG. 9 is a front view of the casing CAS in the present embodiment. FIG. 10 is a side view of the casing CAS in the present embodiment. FIG. 11 is a top view of the casing CAS in the present embodiment. In FIG. 9, the casing CAS is viewed in the direction opposite to the third direction Z. In FIG. 10, the casing CAS is viewed in the first direction X. In FIG. 11, the casing CAS is viewed in the direction opposite to the second direction Y. In FIG. 8 to FIG. 11, the illustration of the leg portions LPA and LPB (shown in FIG. 1) is omitted.

The casing CAS comprises the body portion MP and the frame portion FP. The body portion MP covers at least a part of the display panel PNL. More specifically, the body portion MP covers the mounting area MA and the light source unit LU (the plurality of light sources LS).

In a state where the display device DSP stands independently, the mounting area MA and the body portion MP are located on the side of the installation surface. As shown in FIG. 8, the body portion MP includes a first member 51, a second member 52, and supporting members 53A and 53B.

Each of the first member 51 and the second member 52 has a rectangular shape elongating in the first direction X. The supporting members 53A and 53B are provided between the first member 51 and the second member 52.

The supporting members 53A and 53B are provided on the respective end portions of the body portion MP in the first direction X. The first member 51, the second member 52, and the frame portion FP are connected to each other by the supporting members 53A and 53B and a fixing member 57 (shown in FIG. 9). The fixing member 57 is, for example, a screw. The fixing member 57 is connected not only from the direction opposite to the third direction Z but also from the third direction Z.

In the body portion MP, a space SP is defined by the first member 51, the second member 52, and the supporting members 53A and 53B. A portion including the mounting area MA, of the display panel PNL, is provided in the space SP. As shown in FIG. 11, a first aperture AP1 in communication with the space SP is formed between the first member 51 and the second member 52. The display panel PNL is inserted into the first aperture AP1.

The first aperture AP1 has a shape elongating in the first direction X. The width of the first aperture AP1 in the first direction X is greater than the width of the cover member CM2 in the first direction X. The width of the first aperture AP1 in the third direction Z is greater than the thickness of the display panel PNL in the third direction Z. The thickness of the display panel PNL in the third direction Z corresponds to the distance from the main surface F4 (shown in FIG. 3) of the cover member CM1 to the main surface F8 (shown in FIG. 3) of the cover member CM2.

The body portion MP further comprises a substrate cover 54. The substrate cover 54 overlaps the second member 52 from the third direction Z. The substrate cover 54 is connected to the second member 52, for example, by means of fixing members (for example, a screw).

Next, the frame portion FP will be described.

The frame portion FP includes a first frame 61 and a second frame 62. The first frame 61 and the second frame 62 elongate from end portions of the body portion MP in the first direction X along the second direction Y.

The first frame 61 and the second frame 62 are formed of transparent materials. Here, the term “transparent” means “colorless and transparent”. However, the term “transparent” may mean “semitransparent” or “colored and transparent”. The first frame 61 and the second frame 62 are formed of material such as acrylic, polycarbonate, and glass.

For example, the first frame 61 and the second frame 62 are formed of a single member. This increases the transparency of the first frame 61 and the second frame 62. The first frame 61 and the second frame 62 may be formed of several members.

In the casing CAS, a background can be visually recognized through the first frame 61 and the second frame 62. Thus, when the frame portion FP is viewed from the side of the cover member CM1 through the first frame 61 and the second frame 62, the background of the side of the cover member CM2 (the side of the main surface F8) can be visually recognized, and when the frame portion FP is viewed from the side of the cover member CM2, the background of the side of the first cover member CM1 (the side of the main surface F4) can be visually recognized.

As shown in FIG. 9 and FIG. 10, the first frame 61 includes a first slit 610. As shown in FIG. 9, the second frame 62 includes a second slit 620. The first slit 610 and the second slit 620 are formed along the second direction Y.

The first slit 610 and the second slit 620 do not penetrate the first frame 61 and the second frame 62 in the second direction Y. More specifically, the first frame 61 includes a stopper portion 611, and the second frame 62 includes a stopper portion 621. The stopper portion 611 is located at an edge of the first slit 610. The stopper portion 621 is located at an edge of the second slit 620. The edges are located on a side opposite to the body portion MP in the second direction Y. The stopper portions 611 and 621 close one end of each of the first frame 61 and the second frame 62 in the second direction Y.

Next, the arrangement configuration of the body portion MP of the casing CAS and the mounting area MA of the display panel PNL will be described.

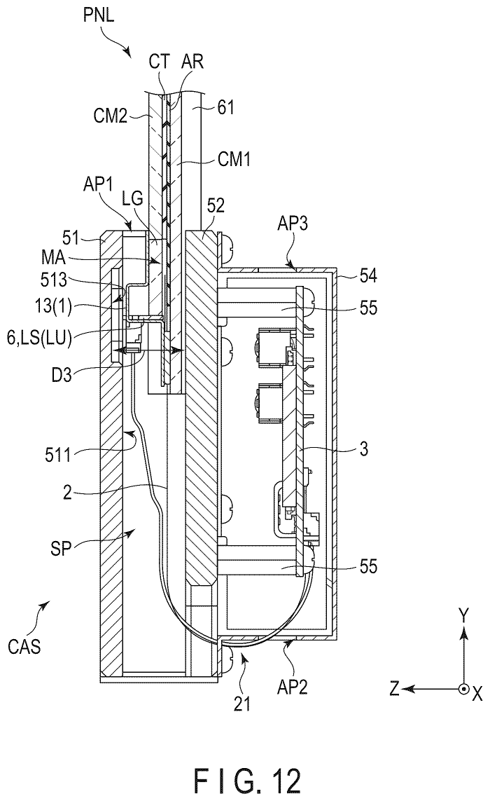

FIG. 12 is a schematic cross-sectional view of the display device DSP along the XII-XII line in FIG. 1. FIG. 12 shows the display device DSP viewed in the direction opposite to the first direction X.

The display panel PNL is inserted into the first aperture AP1. As shown in FIG. 12, the mounting area MA is arranged in the space SP. That is, the first member 51 overlaps the mounting area MA from the direction opposite to the third direction Z (a side of the counter-substrate CT), and the second member 52 overlaps the mounting area MA from the third direction Z (a side of the array substrate AR).

The first member 51 has an inner surface 511 facing the mounting area MA. The inner surface 511 corresponds to a part of surfaces defining the space SP. The inner surface 511 includes a recess portion 513. The recess portion 513 is dented to the third direction Z (a direction extending away from the light source unit LU). The recess portion 513 is formed along the first direction X. A distance between the first member 51 and the second member 52 is the greatest in the recess portion 513. Thus, a distance D3 (the distance between the first member 51 and the second member 52) is sufficient in the recess portion 513.

The recess portion 513 faces the rib 13 of the holding member 1 and the light source unit LU. A gap is formed between the recess portion 513 and the light source unit LU. Thus, even when a force is applied to the casing CAS from the outside of the casing CAS, the force does not easily apply to the light source unit LU.

The outside force may break the light guide LG, deform the holding member 1, and shift the optical axis of the light source LS. These can be a factor for the degradation in display quality. In the present embodiment, the recess portion 513 is formed. Thus, forces do not easily apply to the light source unit LU, suppressing the degradation in display quality in the display device DSP.

As described with reference to FIG. 5, the flexible printed circuit board 2 is bent, and the circuit board 3 overlaps the mounting area MA in the third direction Z. Thus, the width of the body portion MP in the second direction Y can be made smaller. As shown in FIG. 12. the circuit board 3 overlaps the mounting area MA with the second member 52 interposed therebetween.

The circuit board 3 is adjacent to the second member 52 with a gap in the third direction Z. The circuit board 3 is provided on the second member 52, for example, via a plurality of spacers 55. The circuit board 3 is located between the second member 52 and the substrate cover 54.

As shown in FIG. 12, the substrate cover 54 approximately has a U-shape. The substrate cover 54 covers the circuit board 3. As shown in FIG. 12, the substrate cover 54 includes a second aperture AP2 and a third aperture AP3. The second aperture AP2 and the third aperture AP3 penetrate the substrate cover 54 in the second direction Y. The circuit board 3 is provided between the second aperture AP2 and the third aperture AP3.

In the example shown in FIG. 11, the second aperture AP2 and the third aperture AP3 have a shape elongating in the first direction X. In the second direction Y, air flow can be made between the second aperture AP2 and the third aperture AP3. The second aperture AP2 and the third aperture AP3 function as heat dissipation ports.

The flexible printed circuit board 2 that has been bent is inserted into the second aperture AP2. In another view point, the second member 52 is located between two portions of the bent flexible printed circuit board 2.

The substrate cover 54, the circuit board 3, the second member 52, the mounting area MA of the display panel PNL, and the first member 51 are arranged in this order in the third direction Z. The cover member CM1 is located between the array substrate AR and the circuit board 3. The second member 52 is located between the cover member CM1 and the circuit board 3.

Next, the arrangement configuration of the frame portion FP of the casing CAS and the cover member CM1 of the display panel PNL will be described. The vicinity of the first frame 61 will be mainly described below. The following descriptions apply to the second frame 62 as well.

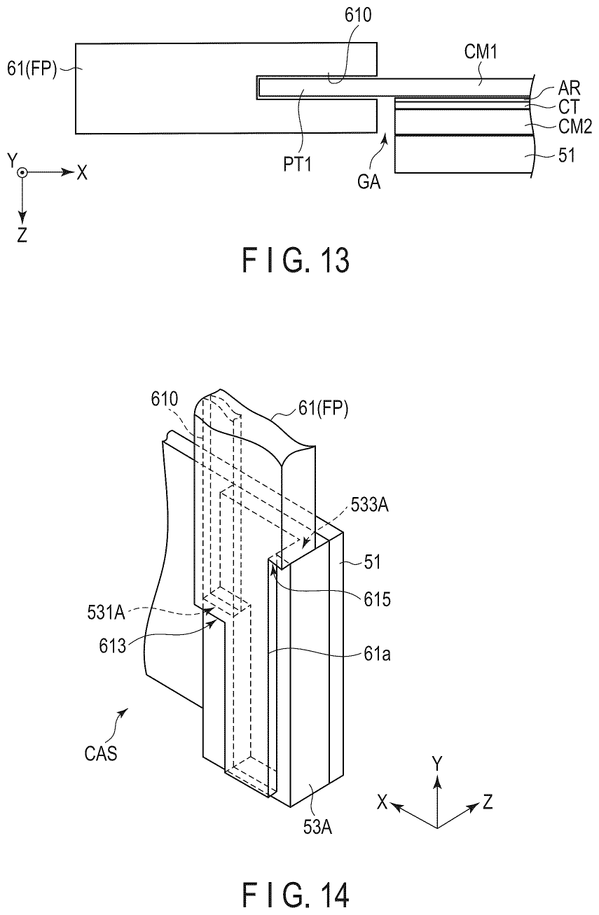

FIG. 13 is a schematic cross-sectional view showing the display device DSP along line XIII-XIII in FIG. 1. As shown in FIG. 13, the first slit 610 is open in the first direction X. Though not shown in the figures, the second slit 620 is open in the direction opposite to the first direction X.

The first frame 61 is provided on the protruding portion PT1. Though not shown in the figures, the second frame 62 is provided on the protruding portion PT2. More specifically, a part of the protruding portion PT1 is inserted into the first slit 610 along the second direction Y. In other words, the first frame 61 is overlapping the part of the protruding portion PT1. Though not shown in the figures, a part of the protruding portion PT2 is inserted into the second slit 620. In other words, the second frame 62 is overlapping the part of the protruding portion PT2. The cover member CM1 and the frame portion FP are transparent. The background can be visually recognized through the frame portion FP even when the protruding portion PT is inserted into the first slit 610 and the protruding portion PT2 is inserted into the second slit 620.

The width of the first slit 610 and the width of the second slit 620 in the third direction Z are greater than the width of the cover member CM1 in the third direction Z. Thus, the cover member CM1 can be inserted into the first slit 610 and the second slit 620 along the second direction Y.

The protruding portions PT1 and PT2 are respectively inserted into the first slit 610 and the second slit 620. Thus, the side surface E2b of the cover member CM1 is in contact with each of the stopper portions 611 and 621 (shown in FIG. 9). In other words, the stopper portion 611 faces an edge portion of the protruding portion PT1. The stopper portion 621 faces an edge portion of the protruding portion PT2.

The first slit 610 and the second slit 620 restrict the movement of the display panel PNL in the third direction Z and the direction opposite to the third direction Z. The casing CAS supports the load from the display panel PNL to the third direction Z and the direction opposite to the third direction Z by means of the first frame 61 and the second frame 62.

The width of the first protruding portion PT1 of the cover member CM1 in the first direction X is greater than the width of the first slit 610 in the first direction X. Though not shown in the figures, the width of the second protruding portion PT2 of the cover member CM1 in the first direction X is greater than the width of the second slit 620 in the first direction X.

As shown in FIG. 13, a gap GA is formed between the first frame 61 and the cover member CM2 in the first direction X. Though not shown in the figures, a gap is formed between the second frame 62 and the cover member CM2 in the first direction X.

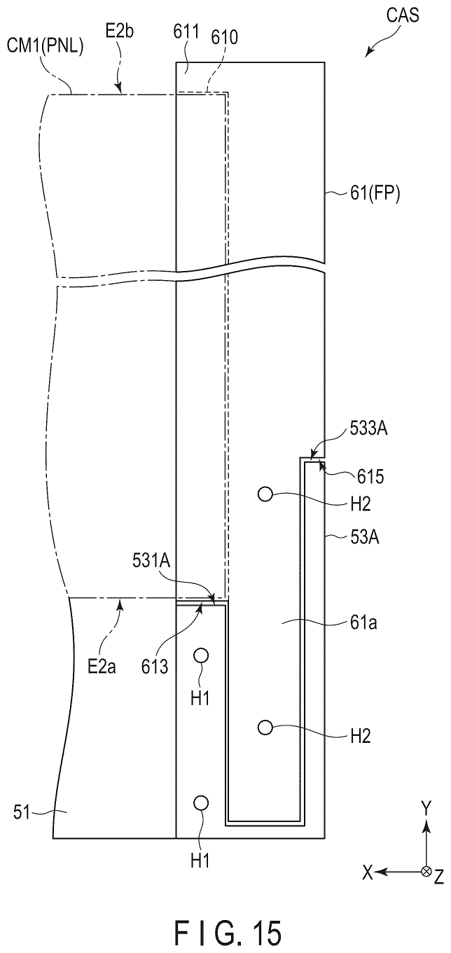

FIG. 14 is a diagram for explaining the relationship between the first frame 61 and the supporting member 53A. FIG. 15 is a diagram for explaining the relationship among the first frame 61, the supporting member 53A, and the cover member CM1. In FIG. 14 and FIG. 15, the first frame 61 and the supporting member 53A are viewed from a side of the second member 52.

In FIG. 14, the first frame 61 is shown in the transparent manner. In FIG. 15, the cover member CM1 is indicated by one-dot chain line. In FIG. 14 and FIG. 15, the illustration of the second member 52 and the substrate cover 54 and the like is omitted.

The first frame 61 includes an end portion 61a. Of the first frame 61, the end portion 61a corresponds to a portion provided between the first member 51 and the second member 52. The end portion 61a includes a portion extending relative to the first slit 610 in the direction opposite to the second direction Y.

The width of the end portion 61a in the first direction X is smaller than the width of the other portion of the first frame 61 in the first direction X. As shown in FIG. 14, the end portion 61a is connected to the supporting member 53A. As shown in FIG. 8, the inner surface of the second member 52 is inwardly bent on a portion overlapping the end portion 61a.

The first frame 61 includes surfaces 613 and 615. The surfaces 613 and 615 face the direction opposite to the second direction Y. The supporting member 53A includes surfaces 531A and 533A. The surfaces 531A and 533A face the second direction Y. The surfaces 531A and 533A are formed by that, of the supporting member 53A, a part of a surface facing the end portion 61a protrudes in the direction opposite to the third direction Z.

The surface 531A faces the surface 613. The surface 533A faces the surface 615. A gap is formed between the first frame 61 and the supporting member 53A in FIG. 15. This gap may not be formed. In the example shown in FIG. 15, the end portion 61a of the first frame 61 is located between the surface 531A and the surface 533A in the first direction X.

As shown in FIG. 14, the first slit 610 is open in the direction opposite to the second direction Y on the second surface 613. The surface 531A faces this aperture of the first slit 610. For convenience of illustration, a gap is provided between the surface 531A and the side surface E2a in FIG. 15. However, the surface 531A is in contact with the side surface E2a of the cover member CM1.

Thus, the supporting member 53A supports the cover member CM1. Similarly, the supporting member 53B supports the cover member CM1. As a result, the whole of the display panel PNL can be supported by the supporting members 53A and 53B.

In the display device DSP, the supporting members 53A and 53B and the stopper portions 611 and 621 restrict the movement of the display panel PNL in the second direction Y and the direction opposite to the second direction Y.

As shown in FIG. 15, a plurality of through holes H1 and H2 to which a fixing member such as a screw can be attached are formed in the supporting member 53A and the end portion 61a. A connection structure of the body portion MP and the frame portion FP is a mere example. Other structures may be adopted.

The display device DSP configured as described above can improve aesthetic appearance. More specifically, a background of each of the transparent frame portions FP which the casing CAS comprises (first frame 61 and second frame 62) can be visually recognized. Thus, the background can be visually recognized in not only through the display panel PNL but also through the frame portion FP, increasing aesthetic appearance of the display device DSP. Further, the display panel PNL and the frame portion FP blend into the surrounding. Thus, the display device DSP does not easily spoil the beauty of the surrounding.

In the present embodiment, when the circuit board 3 is accommodated in the body portion MP, the flexible printed circuit board 2 is bent and the circuit board 3 overlaps the mounting area MA. As a result, as described with reference to FIG. 4 and FIG. 5, the area of a frame portion of the side of the installation surface in the display device DSP can be made smaller. Thus, aesthetic appearance of the display device DSP can be further improved.

In the display panel PNL, the cover member CM1 is inserted into the first slit 610 and the second slit 620 with respect to the first frame 61 and the second frame 62. That is, the display panel PNL is fixed to the frame portion FP by means of a fixing member such as a screw.

This makes the structure of the first frame 61 and second frame 62 simple. More specifically, the width of the first frame 61 and second frame 62 in the first direction X can be made smaller. Thus, aesthetic appearance of the display device DSP can be further improved.

When an adhesive member such as a double-sided tape is provided in a certain area A (indicated by broken line in FIG. 4) in the surrounding area SA, light emitted from the light source LC escapes, is reflected, or the like. Therefore, luminance gradient varies in the display panel PNL, and thus display quality may be decreased.

In the present embodiment, the protruding portions PT1 and PT2 are respectively inserted into the first slit 610 and the second slit 620 in order to support the display panel PNL. Thus, a double-sided tape does not need to be provided in the area A. Thus, the display device DSP can suppress undesired variance in the luminance gradient in the display panel PNL and thus suppress the degradation in display quality.

All of display devices and casings that can be implemented by a person of ordinary skill in the art through arbitrary design changes to the display device and the casing described above as each embodiment of the present invention fall within the scope of the present invention as long as they are in keeping with the spirit of the present invention.

Various types of the modified examples are easily conceivable within the category of the ideas of the present invention by a person of ordinary skill in the art and the modified examples are also considered to fall within the scope of the present invention. For example, even if a person of ordinary skill in the art arbitrarily modifies the above embodiments by adding or deleting a structural element or changing the design of a structural element, or by adding or omitting a step or changing the condition of a step, all of the modifications fall within the scope of the present invention as long as they are in keeping with the spirit of the invention.

Further, other effects which may be obtained from the above embodiments and are self-explanatory from the descriptions of the specification or can be arbitrarily conceived by a person of ordinary skill in the art are considered as the effects of the present invention as a matter of course.

What is claimed is:

1. A display device, comprising:
a display panel including a first surface, a second surface on a side opposite to the first surface, and a mounting area including a terminal; and
a casing supporting the display panel, wherein
the casing includes:
a body portion covering the mounting area; and
a transparent frame portion connected to the body portion,
a background of a side of the second surface is visually recognizable from a side of the first surface, and
a background of the side of the first surface is visually recognizable from the side of the second surface.

2. The display device of claim 1, wherein
the display panel includes:
an array substrate including a pixel electrode;
a counter-substrate facing the array substrate; and
a liquid crystal layer having polymer dispersed liquid crystals and located between the array substrate and the counter-substrate, and
the mounting area is provided at a position of the array substrate, the position not overlapping the counter-substrate.

3. The display device of claim 2, further comprising:
a plurality of light sources arranged in a first direction and emitting light toward the display panel in a second direction intersecting the first direction, wherein
the mounting area and the counter-substrate are arranged in the second direction in a planar view,
the body portion covers the plurality of light sources, and
the frame portion extends along the second direction.

4. The display device of claim 3, wherein
the display panel further includes:
a first transparent cover member including the first surface and facing the counter-substrate; and
a second transparent cover member including the second surface, facing the array substrate, and having a width in the first direction greater than a width of the first cover member in the first direction;
the second cover member includes a first protruding portion and a second protruding portion, the first and second protruding portions protruding from the array substrate in a planar view,
the array substrate is located between the first protruding portion and the second protruding portion in the first direction in a planar view, and
the frame portion includes a first frame overlapping a part of the first protruding portion and a second frame overlapping a part of the second protruding portion.

5. The display device of claim 4, wherein
the first frame includes a first slit to which the part of the first protruding portion is inserted, and
the second frame includes a second slit to which the part of the second protruding portion is inserted.

6. The display device of claim 4, wherein
each of the first frame and the second frame is formed of a single member.

7. The display device of claim 3, wherein
the body portion includes a recess portion facing the plurality of light sources and denting in a direction away from the plurality of light sources.

8. The display device of claim 4, further comprising:
a circuit board overlapping the mounting area; and
a flexible printed circuit board which is connected to the terminal and the circuit board.

9. The display device of claim 8, wherein
the second cover member is located between the array substrate and the circuit board.

10. The display device of claim 9, wherein
the body portion includes a first member overlapping the mounting area from the side of the first surface and a second member overlapping the mounting area from the side of the second surface, and
a first aperture portion to which the display panel is inserted is formed between the first member and the second member.

11. The display device of claim 10, wherein
the second member is provided between the second cover member and the circuit board.

12. The display device of claim 11, wherein
the casing further includes a substrate cover covering the circuit board,
the circuit board is located between the second member and the substrate cover, and
the substrate cover includes a second aperture portion to which the flexible printed circuit board is inserted.

13. A casing supporting a display panel, the casing comprising:
a body portion covering a mounting area of a display panel; and
a transparent frame portion connected to the body portion, wherein
the display panel includes a first surface, a second surface on a side opposite to the first surface, and a terminal included in the mounting area,
a background of a side of the second surface is visually recognizable from a side of the first surface, and
a background of the side of the first surface is visually recognizable from the side of the second surface.

14. The casing of claim 13, wherein
the body portion includes a recess portion facing the mounting area and denting in a direction to be away from the mounting area.

15. The casing of claim 14, wherein
the display panel includes a plurality of light sources provided along the mounting area,
the body portion includes a first member overlapping the mounting area from the side of the first surface and a second member overlapping the mounting area from the side of the second surface,
the first member includes the recess portion, and
the recess portion faces the plurality of light sources and dents in a direction away from the plurality of light sources.

16. The casing of claim 13, wherein
the display panel further includes:
an array substrate including a pixel electrode;
a counter-substrate facing the array substrate;
a liquid crystal layer having polymer dispersed liquid crystals and located between the array substrate and the counter-substrate;
a first transparent cover member including the first surface and facing the counter-substrate; and
a second transparent cover member including the second surface, facing the array substrate, and having a width in a first direction greater than a width of the first cover member in the first direction, the first direction being a longitudinal direction of the mounting area,
the second cover member includes a first protruding portion and a second protruding portion, the first and second protruding portions protruding from the array substrate in a planar view,
the array substrate is located between the first protruding portion and the second protruding portion in the first direction in a planar view, and
the frame portion includes a first frame overlapping a part of the first protruding portion and extending in a second direction intersecting the first direction and a second frame overlapping a part of the second protruding portion and extending in the second direction.

17. The casing of claim 16, wherein
the first frame includes a first slit to which the part of the first protruding portion is inserted, and
the second frame includes a second slit to which the part of the second protruding portion is inserted.

18. The casing of claim 17, wherein
each of the first frame and the second frame includes a stopper portion at an edge of the first slit and the second slit respectively, the edge being provided at a side opposite to the body portion,
the stopper portion of the first frame faces an edge portion of the first protruding portion, and
the stopper portion of the second frame faces an edge portion of the second protruding portion.

19. The casing of claim 16, wherein
the body portion includes a first member overlapping the mounting area from the side of the first surface and a second member overlapping the mounting area from the side of the second surface, and
a first aperture portion to which the display panel is inserted is formed between the first member and the second member.

20. The display device of claim 19, further comprising:
a substrate cover, wherein
the display panel includes a circuit board overlapping the mounting area and a flexible printed circuit connected to the mounting area and the circuit board, and
the substrate cover covers the circuit board and includes a second aperture portion to which the flexible printed circuit board is inserted.
